(19) United States
(12) Patent Application Publication
(10) Pub. No.: US 2004/0054821 A1
(43) Pub. Date: Mar. 18, 2004

(54) Multifunctional network interface node

(76) Inventors: Christopher E. Warren, Columbus, OH (US); Richard L. Shoaf, Columbus, OH (US)

Correspondence Address: BATTELLE MEMORIAL INSTITUTE, 505 KING AVENUE, COLUMBUS, OH, 43201-2693, US

(21) Appl. No.: 10/663,147

(22) Filed: Sep. 15, 2003

Related U.S. Application Data
(63) Continuation of application No. 09/643,395, filed on Aug. 22, 2000, now abandoned.

(51) Int. Cl. G06F 3/00

(52) U.S. Cl. 710/8

(57) ABSTRACT

A flexible, user-configurable, multifunctional network interface node capable of communicating with and controlling a plurality of system devices, including digital, analog, and serial devices. The network node includes two basic components: (a) user-configurable software which provides a common software interface for different system devices; and (b) hardware which provides a hardware interface for the system devices and executes various functions as directed by the user-configurable software.

### BACKGROUND OF INVENTION

The field of the present invention relates generally to systems for operating networked devices and subsystems which utilize different electronic communication formats, and specifically to intelligent electronic nodes that provide common software and hardware interfaces for such devices and subsystems.

Vehicles such as automobiles, military vehicles, recreational watercraft, naval vessels, and aircraft are often highly complex, mobile platforms which include a variety of peripheral devices, sensors, and subsystems. These peripheral devices, sensors, and subsystems, referred to generically as “system devices,” permit the operator of the vehicle to control certain aspects of vehicle performance, and to assess the operational efficiency and overall condition of the vehicle at any given time. System devices may include mechanical and electrical devices such as electronic compasses, water temperature sensors, engine and wheel RPM sensors, engine temperature sensors, oil pressure sensors, radar systems, global positioning systems, and video systems. These devices frequently utilize different electronic communication formats, including digital, analog, or serial type protocol code.

For the operator of a vehicle to conveniently utilize various simultaneously functioning system devices, there is a need for an integrated system which provides (i) a network across which system devices communicate with, and are controlled by, the operator, (ii) a common network interface for digital, analog, serial, or other devices, and (iii) a processing unit which includes at least one viewing terminal for controlling the operation of the system devices, and for viewing relevant information. The common network interface may be provided by a network interface node. This network interface node should include both software and hardware capable of (a) standardizing digital, analog, and serial communication formats, and (b) standardizing the signal output level of the various system devices.

Known systems designed for similar purposes include U.S. Pat. No. 5,953,681 issued to Canatore et al. which discloses an autonomous node for a test instrument system having a distributed logical nodal architecture. This device includes a node apparatus for analytical instrument system having a system controller and a CANBUS, including a CANBUS interface connected to a CANBUS, a microcontroller connected to the CANBUS interface, and at least one circuit responsive to the microcontroller which is operable to perform an analytic instrument function.

U.S. Pat. No. 5,862,401 issued to Barclay discloses a stand-alone programmable central intelligence controller and distributed intelligence network for analog or digital systems which includes a programmable microprocessor-based controller for storing multiple operation instruction sets for independently controlling system components.

U.S. Pat. No. 5,841,992 issued to Martin discloses a network to serial device converter programmably adaptable for interfacing a data processing system to any one specific device selected from a plurality of selectable serial devices.

U.S. Pat. No. 5,772,963 issued to Cantacore et al. discloses an analytical instrument having a control area network and distributed logical nodes, wherein each of the nodes has a CAN microcontroller and related circuitry for performing autonomously a variety of functions of the instrument.

U.S. Pat. No. 5,671,355 issued to Collins discloses a reconfigurable network interface apparatus and method which includes a reconfigurable transceiver and transceiver configuration input for receiving hardware and software transceiver configuration instructions in any of a plurality of network hardware protocols.

U.S. Pat. No. 5,535,336 issued to Smith et al. discloses an apparatus and method for enabling a network interface to dynamically assign an address to a connected computer and establishing a virtual circuit with another dissimilar network interface.

U.S. Pat. No. 4,535,403 issued to Holland discloses a signal generator for interfacing a digital computer to a plurality of devices which includes an apparatus which permits a computer adapted to directly select one of a predetermined number of peripheral devices to interface with more than the predetermined number of peripheral devices.

See also U.S. Pat. No. 5,978,578 to Azarya which discloses an openbus system for control of automation networks and U.S. Pat. No. 5,669,009 to Buktenica et al. which discloses a signal processing array.

Despite some functional equivalence, the systems, devices, methods discussed above are subject to significant limitations in that (i) they do not offer a common software interface between various digital, analog, and serial devices; (ii) they are limited in their end-user configurability, and as such are relatively inflexible following installation; and (iii) they offer either no expandability, or only limited expandability, both in terms of software and hardware capabilities.

### SUMMARY OF THE INVENTION

These and other deficiencies of the prior art are overcome by the present invention which provides an intelligent, highly configurable, multifunctional network interface node (“MNIN”) which is capable of communicating with and controlling a plurality of system devices, including digital, analog, and serial devices. Broadly, MNIN includes two basic components: (a) user-configurable software (firmware) which provides a common software interface for different system devices; and (b) hardware which provides a common hardware interface for system devices, and executes multiple functions as commanded by the user-configurable software.

According to the present invention, MNIN is essentially a circuit board which provides a hardware/software network interface between various system devices and a processing unit functioning as an end-user terminal. Typically, the system devices and processing unit communicate with one another across a controller area network (CAN) bus, or other network interface system. A broad embodiment of MNIN provides a common interface for all information gathering devices, control devices, or subsystems connected to the network, and allows the user of the system to access and control all such system devices from a single terminal, or multiple terminals if so desired. In alternative embodiments, MNIN itself is networked with other network interface nodes which are connected to additional sensors, peripheral devices, systems, and subsystems.

MNIN's flexibility lies primarily in a plurality of individually configurable digital, analog, and/or serial inputs and outputs. Additionally, the node's hardware architecture supports “in circuit programming.” Thus, by using the processing unit to update the firmware, the node is completely reconfigurable across the network interface or through a high speed serial interface.

Typically, MNIN functions as a central component in systems which gather and process information, or in which the end-user controls a plurality of peripheral devices and/or subsytems from one or more terminals. The present invention is designed to (i) be integrated into systems utilizing a wide variety of system devices; (ii) interface with a variety of networks, and (iii) interface with a variety of data or information processors (i.e., terminals) such as personal computers.

Potential applications for MNIN include factory automation, vehicles, (construction, agricultural, recreational), marine vessels, aircraft, power control, medical systems, robotics, sensor monitoring. Contemplated implementations and interfaces include: positioning, mapping, navigation, electronic compasses; engine monitoring including fuel level, voltages, oil pressure, temperatures, power control, pumps, lighting, communications systems, and video multiplexing.

Therefore, it is an object of this invention to provide a flexible, user-configurable network node which acts as common interface for analog, digital, and serial devices, and devices utilizing other communication formats.

It is also an object of the present invention to provide a flexible, user-configurable network node that is compatible with a Controller Area Network or any other suitable network.

It is a further object of the present invention to provide a multifunctional network interface node which is expandable and upgradable without removing the hardware following installation of the multifunctional network interface node on a moving platform.

It is a further object of the present invention to provide a system that enables a user to select from a variety of system devices operating simultaneously and view information gathered by one or more of these devices at a single end-user terminal.

It is a further object of the present invention to provide a system that will enable a user to control a plurality of devices or subsystems from a single end-user terminal.

Further objects, advantages, and novel aspects of this invention will become apparent from a consideration of the figures and subsequent detailed description.

### BRIEF DESCRIPTION OF THE DRAWINGS

FIG. 1. is a simplified block diagram representing the switching capability of the multifunctional network interface node, whereby any variety of incoming or outgoing signals are recognized, processed accordingly, and sent via the network to or from the processing unit.

FIG. 2a is a simplified block diagram representing a preferred embodiment of the architecture of the software utilized by the multifunctional network interface node.

FIG. 2b is a simplified block diagram representing a preferred embodiment of the architecture of the software utilized by the multifunctional network interface node.

FIG. 2c is a simplified block diagram representing an application specific embodiment of the architecture of the software utilized by the multifunctional network interface node.

FIG. 3 is a simplified block diagram representing a preferred embodiment of the architecture of the hardware utilized by the multifunctional network interface node.

FIG. 4a is a simplified block diagram representing an embodiment of the present invention in which the multifunctional network interface node is configured as a sensor interface and RS-232/Digital Interface with no interface circuitry between the node and the sensor devices.

FIG. 4b is a simplified block diagram representing an embodiment of the present invention in which the multifunctional network interface node is configured as a power switch node with no interface circuitry between the node and power switch relay array.

FIG. 4c is a simplified block diagram representing an embodiment of the present invention in which the multifunctional network interface node is configured as a Global Positioning System (GPS) node with no interface circuitry between the node and the GPS unit.

FIG. 4d is a simplified block diagram representing an embodiment of the present invention in which the multifunctional network interface node is configured as a video switch node with interface circuitry between the node and video devices.

### REFERENCE NUMERALS

100 Signal Switching System

110 Microprocessor

130 Transmit Switch

132 First Digital Signal

134 Transmit Pathway

136 Transmit Switch

138 First Digital Switch Control

140 First I/O Connector

150 Receive Switch

152 Second Digital Signal

154 Receive Pathway

156 Receive Switch

158 Second Digital Switch Control

160 Second I/O Connector

200 Node Core Subunit

210 Application Manager Layer

212 Memory Management Module

214 Application Module Management Module

216 FLASH Programming Module

220 Application Module Layer

222 Application Module 1

224 Application Module 2

226 Application Module N

230 Hardware Extraction Layer

232 CAN Module

234 A/D Module

236 Digital I/O Module

238 Timer Module

240 Serial Module

250 CAN Network Interface

252 Asynchronous Serial Port

254 Synchronous Serial Port

256 A/D Converter

258 Time Processing Unit

260 Digital I/O and RS-232 Interface Connector with Power

262 A/D and Digital I/O Interface Connector with Power

300 MNIN Hardware Architecture

310 Node Processing Subunit

312 Address and Data Bus Interface

314 Asynchronous Serial Port

316 Synchronous Serial Port

318 Background Debugging Monitor

320 CAN Network Interface

322 Microprocessor Core

324 A/D Converter

326 Time Processing Unit

330 Memory Subunit

332 Volatile Memory Block

334 Non-volatile Memory Block

340 Digital I/O and RS-232 Subunit

342 Digital I/O and RS-232 Interface Connector

344 Switch Array

350 Power Supply Subunit

352 Power Supply Interface Connector

354 On-board power supply

360 A/D Digital I/O Interface Subunit

362 A/D Digital I/O Interface Connector

370 High-Speed RS-232 Interface Connector

372 RS-232 Transceiver

374 Synchronous Serial Port Interface Connector

376 Background Debugging Monitor Interface Connector

378 CAN Network Connector

380 Processor

400 Sensor Interface and RS-232/Digital Interface Node

402 Power Switch Node

404 GPS Node

406 Video Switch Node

410 Node Enclosure

420 Node Core Subunit

422 Microprocessor

424 Network Interface Connector

426 Power Supply Interface Connector

428 A/D and Digital I/O Interface Connector with Power

430 Digital I/O and RS-232 Interface Connector with Power

432 Network

434 Power Supply

440 Water Temperature Interface Connector

441 Engine RPM Sensor Interface Connector

442 Wheel RPM Sensor Interface Connector

443 Engine Temperature Sensor Interface Connector

444 Oil Pressure Interface Connector

450 External GPS Interface Connector (RS-232)

451 Electronic Compass Interface Connector (Digital)

460 Switch Array Power Supply

462 Relay Array

464 Power Switch

470 Commercial GPS Unit (Digital)

471 External GPS Interface Connector (RS-232)

480 Video Interface Circuitry

482 Video Sources

484 Video Display System

### DETAILED DESCRIPTION OF INVENTION

A preferred embodiment of the present invention provides a flexible, end-user configurable network node for communicating with and/or controlling a plurality of system devices connected to the node by means of a network. This multifunctional network interface node (MNIN) provides common software and hardware interfaces for a wide variety of digital, analog, serial devices, and other devices and permits the user of a system which utilizes MNIN to both operate the system, and to reconfigure the system, from a single terminal. MNIN communicates with the user terminal across a network bus, and from a single terminal, or from multiple terminals, the user of the system may receive and visualize information from a variety of sensors and devices, and may control a variety of sensors, devices, and subsystems.

In the detailed description the present invention the following abbreviations and designations are used: SRAM: static random-access memory (volatile memory); FLASH (nonvolatile memory); EPROM: electrically programmable read-only memory (permanent memory); EEPROM: electrically erasable programmable read-only memory; CAN: controller area network; A/D: analog to digital; I/O: input/output; ESD: electrostatic discharge; PWM: pulse-width modulation; TTL: transistor to transistor logic; TPU: time processing unit; and NMEA: National Marine Electronics Association.

A broad embodiment of MNIN includes the following components: (i) a user-configurable software component (“firmware”) which provides a common software interface for information received from multiple sources; and (ii) a hardware component to which system devices are connected, and for executing various functions as directed by the user-configurable software. As part of a complete automated system, MNIN also requires a processing unit for controlling operation of the entire system, and a communication network for connecting MNIN to the system devices and the processor.

A preferred embodiment of the firmware component further includes: (a) an application manager for facilitating multiprocessing, resource allocation, memory management and cooperation among independent application modules, (b) application modules for application-dependent processing of inputs and outputs; and (c) a hardware abstraction layer to consolidate all MNIN hardware interfaces accessible from application modules by means of certain exported software interfaces.

A preferred embodiment of the hardware component further includes: (a) memory for storing the firmware; (b) a microprocessor for controlling the operation of the node as directed by the firmware; (c) a plurality of input and outputs (I/Os) for communicating with system devices connected to MNIN; and (d) a power supply. The flexibility of the present invention derives from the plurality of individually configurable digital, analog, and serial I/Os which are available to the operator of a system which utilizes MNIN.

In a preferred embodiment, the Controller Area Network (CAN) protocol is utilized with the present invention. The CAN protocol is a serial communication protocol which permits communication between various electronic devices. The CAN protocol allows multiple different electronic devices to be coupled to a single serial bus such that information may be sent from one device to another. However, in alternate embodiments, any suitable network is utilized with this invention. Likewise, any suitable processing unit, including a computer, may be utilized as the terminal with the present invention.

Common Interface Capability

MNIN is capable of communicating with a plurality of analog, digital, or serial system devices. The signal (i.e., voltage) output levels of these devices, as well as their respective network protocols are standardized by MNIN, thereby allowing the end-user of the system to operate these devices from a single terminal (i.e., processor).

MNIN employs signal routing to control the interface level between itself and the devices connected to it. This switching capability may be expanded to include additional signal levels using this signal routing approach, and subsequently adding a variety of receivers and transmitters, thereby expanding the switching options. In addition to different signal levels, different network protocols can be implemented using the received signals and either a proprietary decoder or through modifications made to the MNIN firmware.

The MNIN hardware supports switching the same pin on the microprocessor to either a serial data stream or 5V logic. This switching feature is controlled by the MNIN firmware. Setting a desired bit to logic level 1 or 0 performs a switching function which routes the signal through the appropriate interface circuitry. It is this circuitry that provides the software configurability of present invention.

MNIN includes a plurality of channels which may be used as digital ports. Each of these channels can be configured independently of the other channels, and can be set to one of two voltage levels by means of a control register. When this control register is set for a particular port, on-board circuitry switches the TTL voltage levels (0 to 5V) at the microprocessor pin to a different voltage range, such as an RS-232 (-12 to 12V) range at the digital I/O pin. The MNIN firmware reads the channel configuration for all I/O pins at startup from a configuration block that is stored in the system memory. This configuration block can be loaded onto the node over the network through the system firmware. By adjusting this configuration block and loading a new configuration onto the node, it is possible to adjust voltage levels, and the digital protocol assigned to each channel.

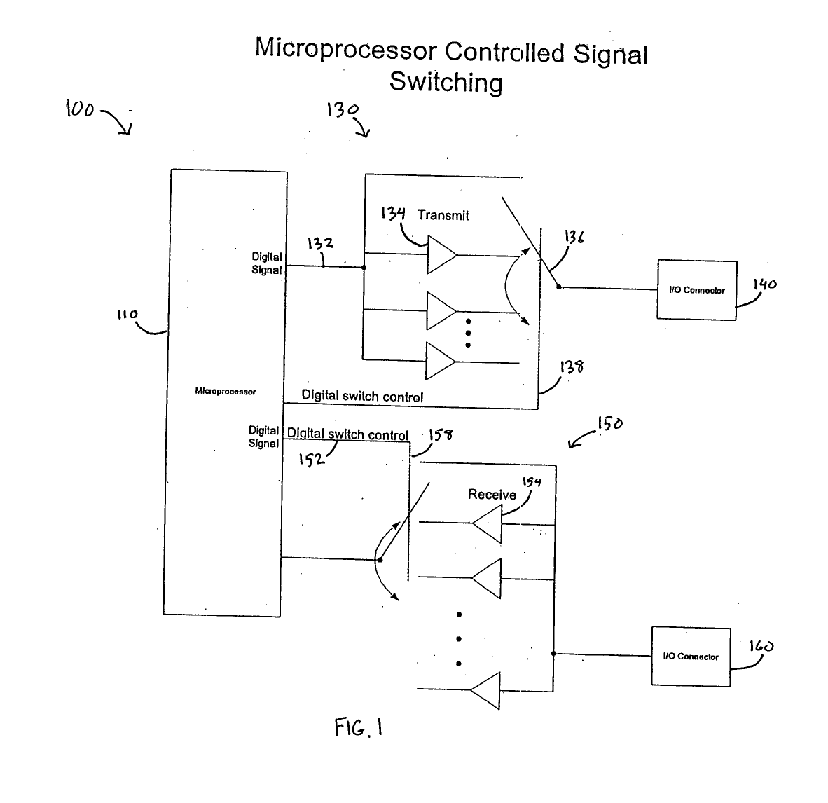

FIG. 1 is a graphical representation of MNIN's switching functionality. In switching system 100, microprocessor 110 desires to send a first digital signal 132 to a system device through transmit switch 130. Based on the device connected to first I/O connector 140, microprocessor 110, through first digital switch control 138, commands transmit switch 136 to select from one of a plurality of possible transmit pathways 134 so that microprocessor 110 may communicate with the device connected to first I/O connector 140. Likewise, microprocessor 110 desires to receive a second digital signal 152 from a system device through receive switch 150. Based on the device connected to second I/O connector 160, microprocessor 110, through second digital switch control 158, commands receive switch 156 to select from one of a plurality of possible receive pathways 154 so that microprocessor 110 may communicate with the device connected to second I/O connector 160.

In a preferred embodiment, each of the digital I/O channels may be configured across the system's communication network. Each channel can be set to one of the following voltage levels: TTL level (0 to 5V) and RS-232 level (−12V to 12V). Additionally, each channel can be set to be one of the following types of data sources or outputs: pulse width modulation; period measurement; interval pulse counting; pulse counters; digital input; digital outputs; and serial communications (Rx or Tx). Depending on the desired type of digital I/O, each channel also may include additional parameters which are stored within the firmware's configuration block. For example, in one embodiment, any channel configured for serial communications also has the following settings defined in the configuration block: baud rate; parity; stop bits; and byte size. An interval pulse counting channel has an update interval as a configurable parameter, and a pulse width modulation channel has a frequency and duty cycle.

A/D channels have information in the configuration block similar to the digital and serial channels. Some examples of software-configurable parameters for analog channels include sample rates; broadcast rates; and loadable calibration tables.

MNIN Firmware Component

Once loaded onto the hardware's memory, the user-configurable software component of the present invention is referred to as “firmware.” The preferred embodiment of the firmware component of the present invention provides many software libraries and services to accommodate efficient development of end-user software modules for MNIN.

The first of these services is referred to as the hardware abstraction layer (HAL). The HAL software shields a higher-level application from directly interfacing with the registers of the microprocessor utilized by MNIN. HAL is analogous to a layer of device drivers that enable the application to send and receive I/O by specifying what needs to occur and when, while not necessarily specifying how a particular task should be executed. HAL provides high-level interface for any device I/O.

A second feature of the MNIN firmware is the event-driven architecture provided for all applications that are developed for the system. This event-driven architecture enables the designer of the end application to consider the end application as a figurative “black box” software component. The process flow is driven entirely by events occurring on the system inputs. The outputs of the process are driven by which particular events occur and when they occur. This capability enables rapid application development because the implementation of the module can often be directly taken from the operational requirements of the module itself.

A third feature of the MNIN firmware is its extensible architecture. Although many interface abstractions are built into the firmware, the architecture can be extended further through wrapper functions to provide even higher-level functionality. An example of a wrapper function that has already been developed is a NMEA parser that resides on top of RS-232 input functions. Instead of handing each individual serial character to the application, this wrapper function waits for NMEA string delimiters and passes the NMEA string (or its parsed data) to the awaiting module. By linking the wrapper functions to the firmware, a new feature is created within the firmware that can be utilized by several different modules.

A fourth feature of the MNIN firmware is the multi-tasking environment that it provides. The MNIN software provides a robust services layer, which allows for task switching between multiple software applications. This capability permits resource allocation and sharing, event notification, and memory management between the software modules. The MNIN firmware also permits the loading of code blocks into memory, whereby each block is kept separate from the data. This facilitates loading multiple instances of the same software module, wherein each module maintains its own data segment. In this operating environment, a code segment would be loaded into memory only once, while one data block would be loaded into the memory space for each individual instance. This approach provides efficient memory usage and process control.

The MNIN firmware also provides additional software services that can be utilized to perform many common types of I/O services. Digital inputs can be provided for a variety of purposes; for example, a first digital input may be required to be notified whenever the line is set or cleared, a second digital input may be required to count pulses over fixed periods of time, while a third digital input may be required to measure the frequency of pulses on one of a plurality of digital inputs. Similarly, digital outputs can have broad functional requirements; for example, a first digital output may be required to switch relays from one logic level to another, while a second digital output may be required to send pulse-width modulation through programmable duty cycles and periods. The MNIN firmware provides abstractions for each of these functions, as well as other functions.

The MNIN firmware utilizes the on-board TPU microprocessor for processing each function, and for synchronizing the event timing with the built-in system clock. This approach minimizes any need for processing by the software module, freeing the CPU for other processing, and releasing the application module from performing this logic. For example, the pulse width modulation function allows the module to set a period and duty cycle for the pulses on any of the digital channels. Once initialized, the pulse width modulation function will continue to run in the background until the application module asks the firmware to change the pulse width modulation rate or turn the function off.

The MNIN firmware also provides I/O buffering by providing input and output FIFO (First In First Out) queues for each individual interface of the hardware. Each application module does not need to maintain its own queue for any input or output unless it has a special need to do so, such as parsing incoming serial strings.

The MNIN firmware also provides diagnostic services by providing a programmable driver for the diagnostic Light Emitting Diode (LED). This driver can be configured to flash the LED in hundreds of unique sequences to aid in state diagnostics for the application module.

The MNIN firmware also provides remote programming and configuration by providing interface libraries that can be used to load code onto and configure data on the hardware from a remote computer over the Controller Area Network, or other network interface. This permits ease of maintenance and debugging of components in the end environment. This can be an important capability when physical access to installed network nodes is difficult or impossible. TABLE 1 lists possible functions of the MNIN firmware.

TABLE 1
Possible Functions of MNIN Firmware.

| Type | Function |
|---|---|
| Serial Debug | RS232 TX/Rx |
| Serial | RS232 Transmit |
| | RS232 Receive |
| | TTL Transmit |
| | TTL Receive |
| Digital I/O Input | Level Check |
| | Pulse Counting |
| | Interval Pulse Counting |
| | Pulse width / Period Measurement |
| Digital I/O Output | Level set |
| | Pulse Width Modulation |
| ND | Read up to 16 channels of 10-bit ND |
| CAN (2.0A, 2.0B) | Receive CAN messages by range of Message Ids |
| | Receive CAN messages by MessageID bit mask. |
| | Transmit CAN messages. |
| Timers | Each application can request timer events |
| | to be generated at programmable intervals. |

A sample user application of the MNIN firmware would be as follows. At startup, or initialization, the application calls functions of the HAL to register as a user of a particular resource (e.g., an RS-232 line, a digital I/O line, a system timer, or a group of CAN messages). At shutdown, the application calls other functions of the HAL to give up the resources claimed at initialization. In between these two points (i.e. during runtime), the application is notified when any of its events are triggered. The application will process its inputs as each event is passed to it. The application does not have to implement its own I/O buffers as these are provided by the HAL. Conceptually, each application within this architecture acts as a switchboard that simply connects the appropriate input events to system outputs. Examples of preferred inputs include RS-232, digital I/O, A/D, CAN messages, or system timers; while examples of preferred outputs include RS-232, digital I/O, or CAN messages.

In a preferred embodiment of the present invention, the MNIN software is transferred to the node hardware memory modules, where it resides following installation. Preferably, these memory modules include SRAM, Flash, and EEPROM modules. In a preferred embodiment, the MNIN software is actually three separate pieces software. The first piece of software is the MNIN software which is loaded onto the top of a Flash memory module, and can be loaded onto the system using a Flash programming utility through the background debugger cable. In an alternative embodiment, the Flash may be inserted into a Flash programming device and programmed using said device. The second piece of firmware is the boot module which sets the chip selects for the appropriate FLASH and SRAM chips, and then jumps into the Flash to begin executing the firmware. This piece of firmware is located at the top of EEPROM. The third piece of firmware is the custom TPU microcode library, and is located at the bottom of the FLASH memory. In an alternative embodiment of the present invention, all three of the MNIN firmware modules are located within the EEPROM, thereby freeing the entire FLASH for user-defined modules.

After the firmware has been installed on the MNIN, the firmware remains configurable (i.e., can be overwritten or updated). Any one of, or all three of the pieces of firmware may be updated or otherwise modified if the interfaces between these modules have not been changed. The MNIN firmware may be updated to roll new functionality into the node that is not implemented in the base libraries. This would typically be for any single functionality that was needed by multiple modules.

The firmware may also be modified to add custom modules to the system, while keeping all modules included in one executable. This modification is advantageous if all nodes of an installation require the exact same set of software as it could help to simplify node software maintenance. For example, four new custom modules could be added to one node. If these four modules are each linked and installed independently, there will be three firmware modules plus four custom modules to maintain on each node. However, if all four modules are linked into the firmware then there would only need to be three modules maintained on each and every node.

The TPU microcode library may also be expanded. As long as the MNIN functions remain at the top of the library, additional TPU functions may be added and called from custom software modules. This can be done without changing the primary MNIN firmware. The boot module may also be updated, if needed. This is done if the user selects an alternative chip in the FLASH or EEPROM circuit, or if additional circuitry is added to the hardware. Primarily, the changed software would simply set up the appropriate select signals according to the new chip arrangement.

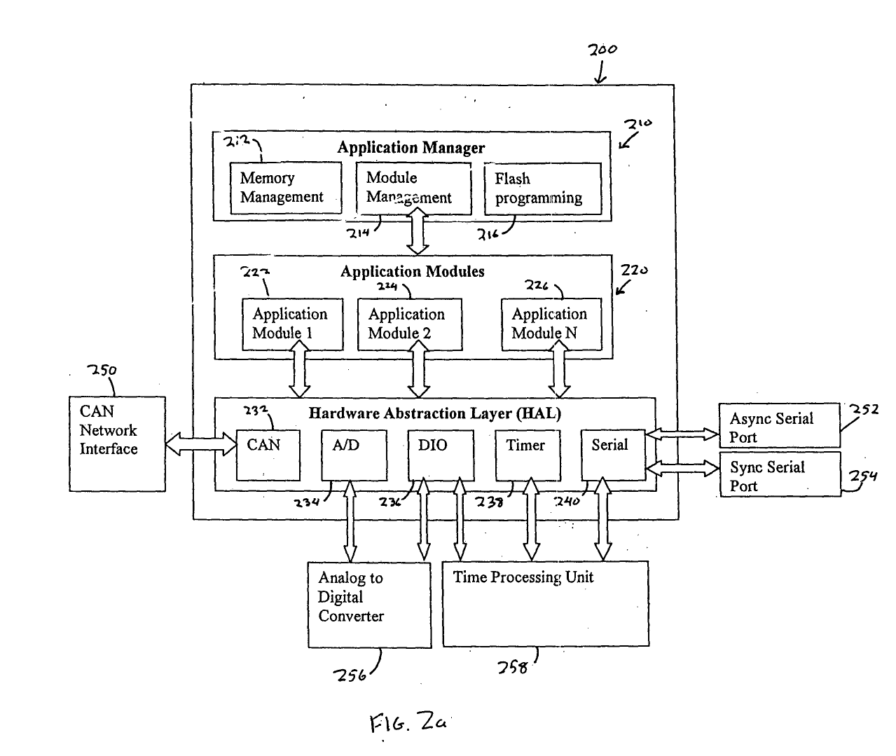

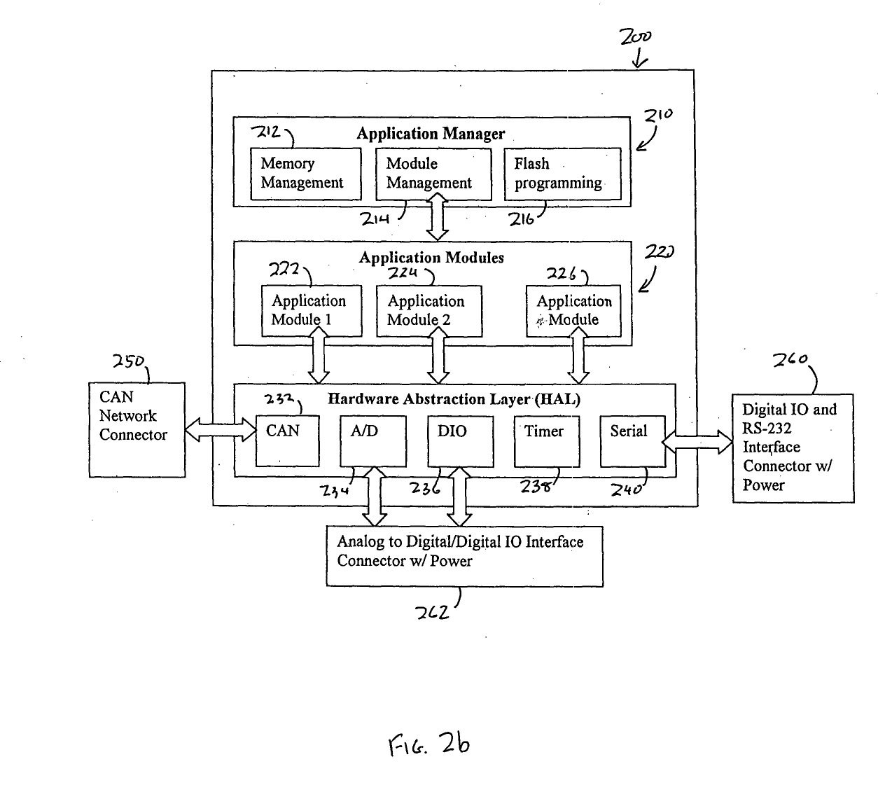

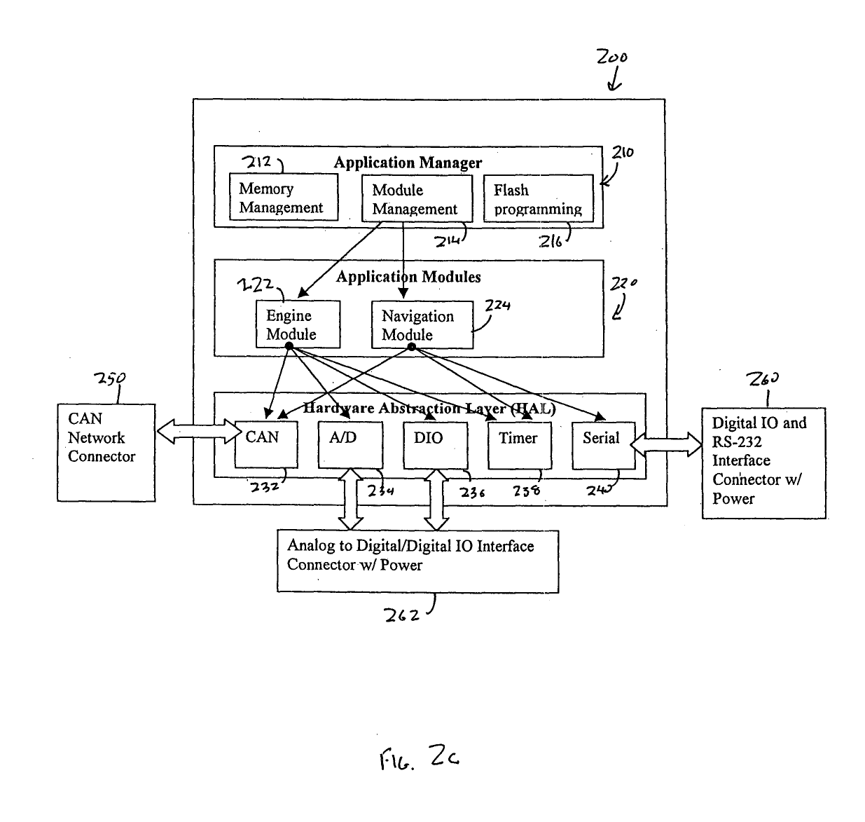

FIGS. 2a and 2b are a block diagrams depicting the general architecture of the MNIN firmware. FIG. 2c depicts an application specific configuration of the MNIN firmware.

In FIG. 2a node core subunit 200 comprises application manager layer 210, application module layer 220, and hardware extraction layer 230. application manager layer 210 further comprises memory management module 212, application module management module 214, and FLASH programming module 216. Application module layer 220 further comprises application modules 222, 224, and 226. Hardware extraction layer 230 further comprises CAN module 232 in communication with CAN network interface 250 (hardware), A/D Module 234 in communication with A/D converter 256 (hardware), digital I/O module 236 in communication with A/D converter 256 (hardware) and time processing unit 258 (hardware), timer module 238 in communication with time processing unit 258 (hardware), and serial module 240 in communication with time processing unit 258 (hardware), asynchronous serial port 252 (hardware), and synchronous serial port 254 (hardware).

In FIG. 2b, A/D Module 234 and digital I/O module 236 are shown in communication A/D and Digital I/O interface connector with power 262 (hardware), and serial module 240 is shown in communication with digital I/O and RS-232 interface connector with power 260 (hardware).

In FIG. 2c, module management module 214 is shown managing application module 222 which is operating as an engine module, and application module 224 which is operating as a navigation module. These application module as shown interacting with the relevant hardware abstract layer modules.

MNIN Hardware Component

The MNIN hardware provides a multiple I/O interface board for connecting to a wide range of system devices including other network nodes and/or system busses. In a preferred embodiment, 16 of 32 I/O pins can be software-configured to communicate either serially (e.g., RS-232, RS-422 or TTL) or as digital I/O. Sixteen remaining pins are software-configurable as analog to digital inputs or as digital I/O. The flexible MNIN hardware provides system scalability, and accommodates growth as application needs change or evolve. Advantageously, the preferred MNIN hardware architecture significantly reduces development times in applications where I/O requirements are not fully defined when a project is initiated.

Examples of analog, digital, and serial devices compatible with MNIN include the following sensor types: acceleration, acoustic, altitude, chemical/gas, density, displacement, distance, electrical, flame, flow, force, friction, humidity, ice, flood level, light, magnetic, mass, moisture, organics, position, pressure (water and oil), radiation, RPM (engine and wheel), sound, speed, strain, surface conditions, temperature, thermal properties, tilt, torque, turbidity, velocity, vibration/shock, voltages, weight, wind direction, and wind speed; and the following device and system types: alarm systems, analog output devices, appliances, depth sounders, digital signal processors, electronic compasses, event counters, fan systems, factory equipment, global positioning systems (GPS), input devices (e.g., mouse, keyboard), light systems, power switch relay arrays, radar systems, real time clocks, tachometers, uninterruptible power supplies, and video systems.

The preferred embodiment of the present invention operates within a temperature range of about minus 40° C. to 85° C. This temperature range is extendable if conditions require operating temperatures outside of the preferred range. Furthermore, all components of MNIN are ruggedized to prevent damage resulting from use in high shock or high vibration environments. A preferred embodiment of MNIN includes no mechanical or moving parts susceptible to failure in extreme operating environments.

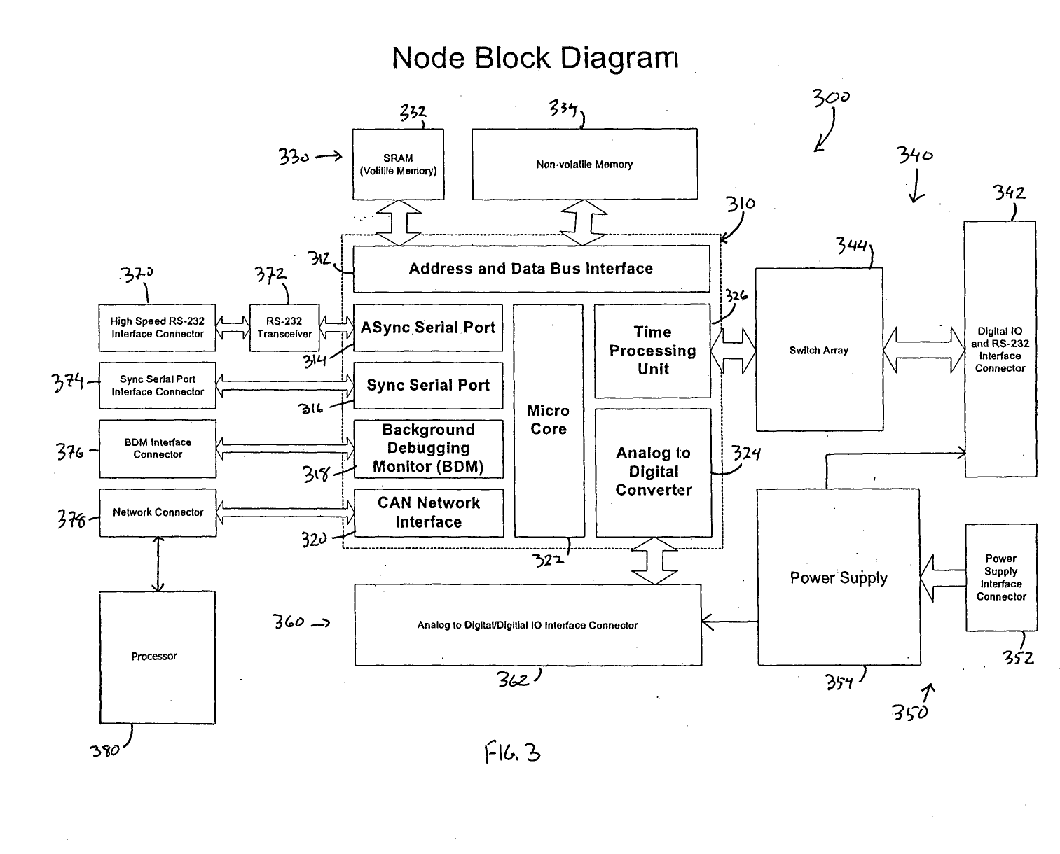

As shown in FIG. 3, and according to a preferred embodiment of the present invention, the MNIN hardware architecture 300 comprises a node processing subunit 310, a memory subunit 330, a Digital I/O and RS-232 subunit 340, a power supply subunit 350, an A/D digital I/O interface subunit 360, a series of additional interface connectors 370, 374, 376, 378, and a processor 380. Most of the individual components of MNIN are commercially available items which may be purchased for the purpose of assembling the preferred embodiment.

Node processing subunit 310 further comprises address and data bus interface 312; asynchronous serial port 314; synchronous serial port 316; background debugging monitor; CAN network interface 320; microprocessor core 322, A/D converter 324 in communication with A/D and Digital I/O interface connector 362, and time processing unit 326 in communication with switch array 344. Preferably, microprocessor core 322 is a Motorola MC68376 32-bit processor running at 19.66 MHz. Other embodiments of the present invention utilize any microprocessor having sufficient processing capabilities and variable speed.

Memory subunit 330, onto which the firmware is loaded, includes volatile memory block 332, which in a preferred embodiment is a SRAM memory module (512 Kbytes); and nonvolatile memory block 334, which in a preferred embodiment includes a FLASH memory module (512 Kbytes) and an EPROM memory module (256 Kbytes or 128 Kbytes). Altnerate embodiments of these memory modules utlize a variety of speeds and sizes.

A/D and Digital I/O interface connector 362 permits analog input signal from any sensor or other device to be digitized and manipulated, and processes up to 16 individually configurable analog inputs at 0 to 5V at a resolution of 10 bits; or 16 serial/digital inputs (8 digital inputs and 8 digital outputs). These channels provide an interface for analog signals as well as providing additional digital control pins. Preferably, A/D and Digital I/O interface subunit 360 includes ESD/overvoltage protection.

Digital I/O and RS-232 interface connector 342 includes 16 bi-directional I/O pins configurable in any combination to provide a generic interface for a wide range of devices. Time processing unit 326 processes up to 16 single-ended I/Os having a digital range of 0 to 5V, or a total of 16 RS-232 bidirectional channels including 8 pairs of transceivers operating at speeds of up to 115.2 Kbps, and having an RS-232 range of −12V to 12V. Alternatively, up to 16 PWM bi-directional channels (0-5V) capable of frequencies up to 76.8 KHz are available. These lines may be used to activate relays, read switches or buttons or any digital input, interface to any serial device (such as a GPS receiver) or communicate on a digital data bus. Preferably, Digital I/O and RS-232 subunit 340 includes ESD/overvoltage protection.

In the preferred embodiment, power is supplied to MNIN by a fully isolated and lighting/ESD protected dual input power supply which provides automatic switching between preferred and backup power sources, thereby ensuring operating continuity in the event of power disruption. The dual power supply inputs include both an external power supply, and the CAN power supply. MNIN can draw sufficient power from either source; however, if both power sources are present simultaneously, the node will choose the external power supply over the CAN power supply to reduce the load on the CAN power supply. Preferably, the external power supply contains over voltage protection, ESD protection, reverse voltage protection, and short circuit protection. In one embodiment of the present invention, the node follows the limit on the amount of power used specified by NMEA2000. Power supply subunit 350 includes power supply interface connector 352, and provides power to digital I/O and RS-232 interface connector 342 and A/D and Digital I/O interface connector 362 for use by external devices requiring power. Preferably, power supply subunit 350 operates within the range of about 8V to 32V DC.

As illustrated in FIG. 3, the preferred embodiment of node processing subunit 310 also provides a series of additional interface connectors including stand-alone asynchronous serial port 314 (providing a separate serial interface for communications at very high data rates above those of the other RS-232 channels, as well as an additional debugging method) in communication with RS-232 transceiver 372 which in turn is in communication with high-speed RS-232 interface connector 370; a stand-alone synchronous serial port 316 (providing an interface for peripheral synchronous devices such as digital to analog converters and additional memory) in communication with synchronous serial port interface connector 374; background debugging monitor 318 in communication with background debugging monitor interface connector 376 which provides a method for application development and monitoring the internal workings of the microprocessor; and CAN network interface 320 in communication with CAN network connector 378 (integrated microprocessor interface) in communication with processor 380. The CAN interface provides a high speed network interface which permits MNIN to interface with other nodes, as well as a computer, slave node, or master node. MNIN also provides the user with the option to terminate the interface or leave the interface unterminated. A preferred embodiment provides two CAN ports such that another device can be easily daisy chained with MNIN. In one embodiment of the present invention, the CAN interface follows NMEA2000 specifications.

### EXAMPLE 1

### Sensor Interface and RS-232/Digital Node

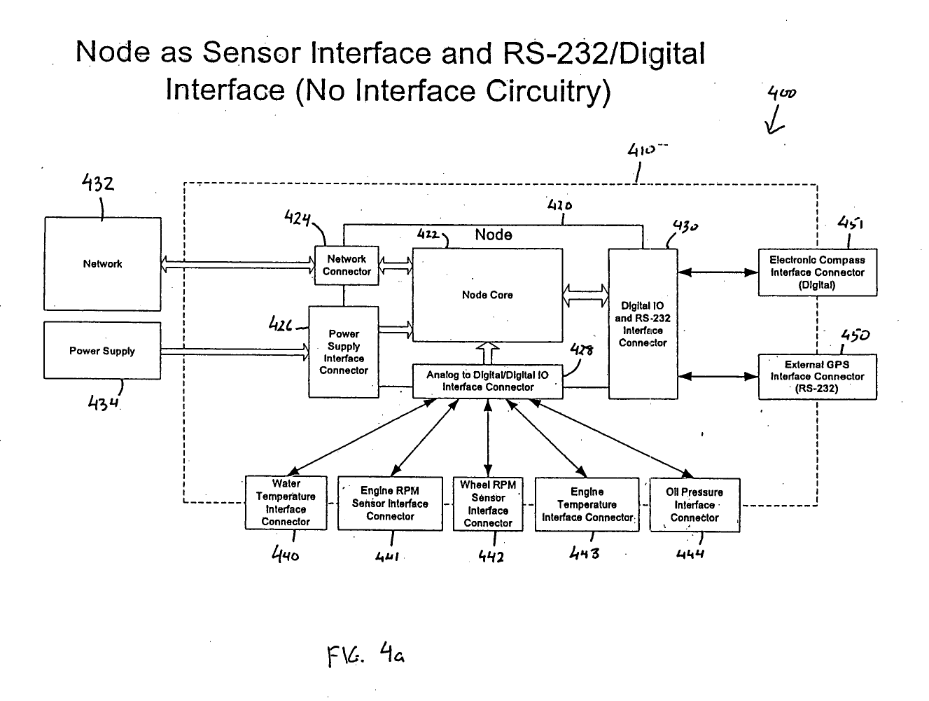

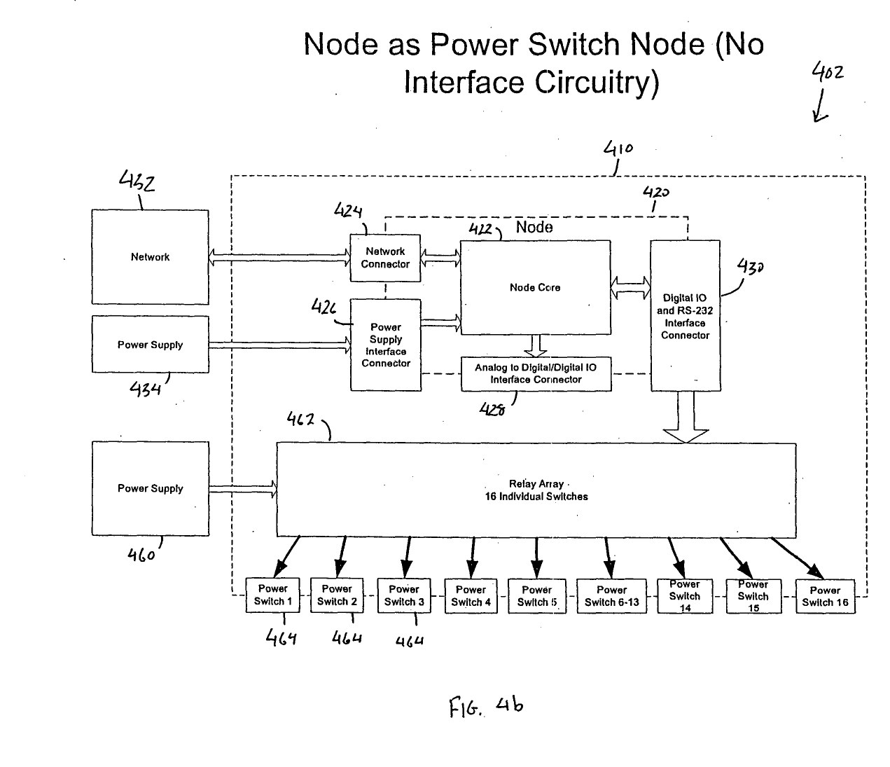

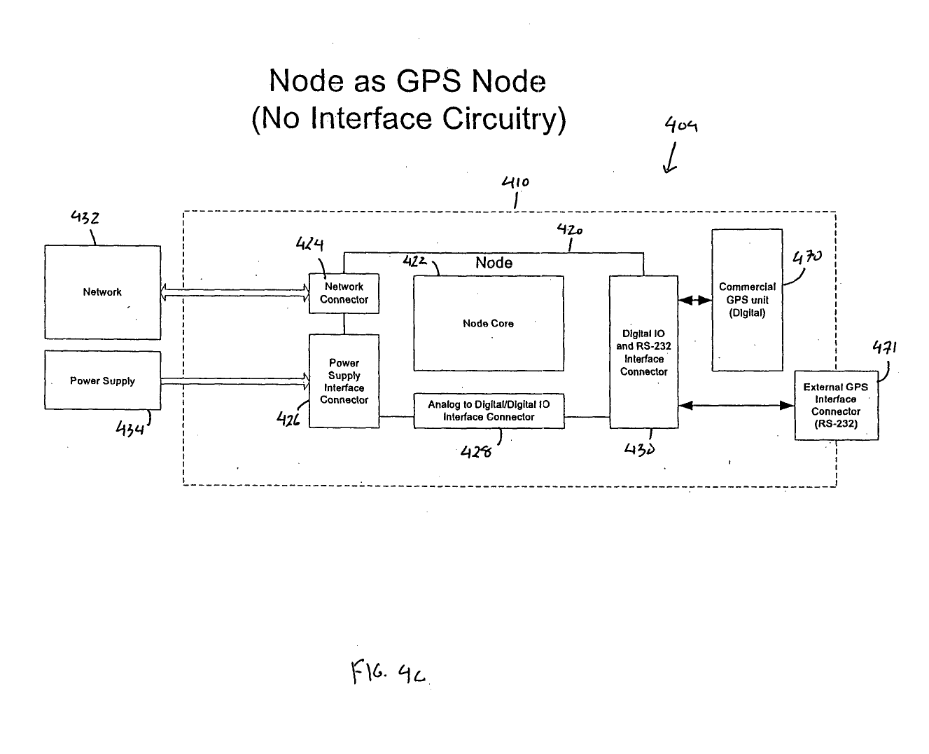

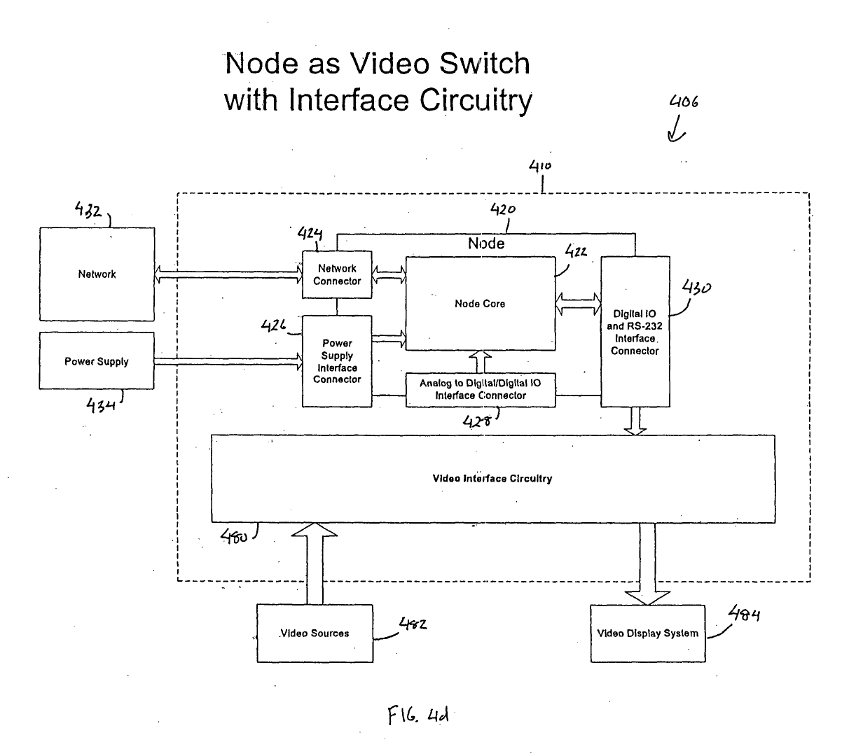

FIG. 4a illustrates an embodiment of the present invention in which MNIN is operating as a sensor interface and RS-232/digital interface where there is no interface circuitry between MNIN and the system devices. This “sensor interface node” includes analog sensors which are input to the A/D converter, as well as 5V pulse signals being input through the signal routing path for 5V signals into the microprocessor for performance of calculations. This embodiment also utilizes the signal routing ability of MNIN to include an interface with additional GPS units by switching the appropriate channel to the transmitter and receiver signal path. In this embodiment, the node can operate independently based on input conditions and change the outputs accordingly, or alternatively, the node can provide sensor information to another device connected to the network.

In FIG. 4a sensor interface and RS-232/digital interface node 400 is housed within node enclosure 410. Node core subunit 420 comprises microprocessor 422 which controls operation of the node; network connector 424 in communication with network 432; power supply interface connector 426 in communication with power supply 434; A/D and Digital I/O interface connector 428; and Digital I/O and RS-232 interface connector 430. In this embodiment, A/D and Digital I/O interface connector 428 communicates with a variety of analog or digital devices through their respective interface connectors, including, water temperature interface connector 440, engine RPM sensor interface connector 441, wheel RPM sensor interface connector 442, engine temperature sensor interface connector 443, and oil pressure interface connector 444. Digital I/O and RS-232 interface connector 430 communicates with a variety of serial or digital devices through their interface connectors, including external GPS interface connector 450 (RS-232) and electronic compass interface connector 451 (digital).

### EXAMPLE 2

### Power Switch Node

FIG. 4b illustrates an embodiment of the present invention in which MNIN is configured as power switch node 402 with no interface circuitry between MNIN and the system devices. Power switch node 402 controls a bank of switches that provide power to peripheral devices such as a computer, lights, pumps, etc. To achieve this, the MNIN outputs (on the same multifunctional lines) control signals to the switches and turn them on or off. Depending on the type of switch used, a 5V control signal is utilized by switching to the 5V signal path, or alternatively, a −12 to 12V signal is utilized by switching to transmitter path. Power switch node 402 can be configured to either control switches depending on inputs, or can be controlled by means of the network interface to activate specified circuits. In FIG. 4b relay array 462 is powered by switch array power supply 460 and is connected to a plurality of power switches 464.

### EXAMPLE 3

### GPS Node

FIG. 4c illustrates an embodiment of the present invention in which MNIN is configured as GPS node 404 with no interface circuitry between MNIN and the system devices. GPS node 404 communicates with an internal commercial GPS unit 470 that uses 5V signal levels by switching to the 5V signal path, and at the same time communicates with an external GPS unit using ±12V signals by switching to the alternate transmitter and receiver paths. Each interface takes advantage of the signal routing ability of MNIN to use the appropriate signal levels without additional circuitry. This embodiment of the GPS node uses the network interface to report information to another device on the network. In FIG. 4c Digital I/O and RS-232 interface connector 430 is in communication with internal commercial GPS unit 470 (digital) and with external GPS interface connector 471 (RS-232) which is connected to an external GPS unit.

### EXAMPLE 4

### Video Switch Node

FIG. 4d illustrates an embodiment of the present invention in which MNIN is configured as video switch node 406 with interface circuitry between MNIN and various video devices. In this embodiment, MNIN interfaces by means of the same multifunctional lines to the video switch which are set at 5V signals by switching to the 5V signal path, but not necessarily restricted to these specific levels. By dictating the appropriate signals, MNIN controls the source and destination of each video signal. The video node can be independent of the network and route signals based on inputs, or can be controlled by means of the network interface to route the video signals as desired. In FIG. 4d, Digital I/O and RS-232 interface connector 430 is in communication with video interface circuitry 480, which is receiving information from video sources 482 and sending information to video display system 484.

In an alternate embodiment (not shown), MNIN interfaces with display circuitry as well as well as user-feedback buttons and a GPS and real-time clock (a display node). The interface with the display circuitry uses 5V signals by selecting the 5V signal path. The user feedback buttons are routed through the 5V signal path for the microprocessor to perform specified actions as well as updating display information. The GPS uses the 5V signal path to communicate information the microprocessor. The real-time clock also uses the 5V signal path to communicate with the microprocessor. MNIN can display information on the display based on feedback from the network as well as send commands to other devices on the network.

In still another embodiment (not shown), MNIN is configured to communicate with up to eight serial devices (such as military radios) using the ±12V signal path to achieve the appropriate signal levels. Using this information, MNIN can send appropriate outputs, or can provide information by means of the network interface to another device on the network.

In a broad sense, MNIN is intended to be used with a larger information processing/controlling system which includes (i) a processing unit/control terminal for controlling the operation of the system; (ii) a network bus for connecting the control terminal to MNIN; (iii) MNIN, for communicating with system devices connected to MNIN; and (iv) a plurality of system devices in communication with MNIN, and controlled or accessed by and through the control terminal. The following examples provide descriptions of systems into which MNIN may be incorporated.

### EXAMPLE 5

### Integrated Bridge System

The increased speed of certain classes of water-going vessels (e.g., high-speed ferries), coupled with increasing traffic densities in confined waters has resulted in a need for certain automated systems on such vessels. In high-speed ferries, manually performed functions, such as those associated with navigation and collision avoidance, tend to lag behind decision-making requirements. Additionally, in the area of naval law enforcement, there is a need to implement automation for tasks requiring faster assimilation of information and/or response than those which humans alone are capable.

Answers to these problems are provided by the Integrated Bridge System (“IBS”) which gives the operator of a mobile platform such as a ship the ability to monitor and control most or all of the subsystems present on a craft. More specifically, IBS is a computer-based platform that enables monitoring, control, and operation of a small to mid-sized high speed craft and its associated navigation, communication, and sensing functions by a single crew member on the bridge of the craft. Essentially, IBS is a tool which enhances the performance of individual watchstanders through automation of selected functions, presentation of essential information in a readily comprehensible format, and providing computer-based decision support.

The key benefits of IBS are its open architecture, ability to add-on multiple applications, scalability, use of commercial off-the-shelf technologies, and ease of installation and support. This flexibility derives from the IBS system architecture which, in a preferred embodiment, includes a plurality of devices (installed at various locations throughout a vessel) in communication with MNIN, which in turn communicates with at least one user terminal across a network such as a Controller Area Network. Specific IBS components include ruggedized flat panel displays, ruggedized computers, high speed local area network, specialized user interfaces, relay interface box, supervisory control and data acquisition systems software (SCADA), and navigation software systems controlled and capabilities provided include precision navigation (electronic charts, GPS, compass), communications, sensors, relay monitoring and control, machinery control, data logging, and alarms.

Further advantages of IBS include: scalability, interface to existing technology, migration path for future systems (enables technology upgrades), use of commercial off-the-shelf technology conferring cost advantages, maximum use of open communication standards, ease of installation and supportability. The IBS architecture supports the addition of functional modules with minimal development and integration.

In a broad sense, IBS is contemplated for use in a wide variety of vehicles, including domestic passenger ships, high speed ferries, towboats, offshore support vessels, recreational boats, warships, naval, military, law enforcement small craft, high speed assault craft, coastal assault craft, and rigid hull inflatable boats.

### EXAMPLE 6

### Driver Display

In this system, a less complex version of MNIN and its associated components (i.e., processor/monitor, and network) are integrated into a single device which communicates with a variety of sensors and subsytems installed in a vehicle such as a military transport. In general, the system supports a small sunlight readable display along with a user interface to control menu selection and functions. The display is driven by a sensor interface that provides a network interface to retrieve sensor data. The sensor network is expandable by adding additional nodes.

More specifically, a preferred embodiment of the Driver Display provides a sunlight readable electro-luminsecent display that can be replaced with any other standard display. Situated around the display are the user interface buttons that are formatted as soft keys, but can be rearranged as needed and have no predetermined function. The display is interfaced to a microprocessor board that provides FLASH memory, battery back SRAM, a Compact FLASH interface (removable memory), a GPS interface for a small commercial GPS (global positioning system) as well as a power system and network interface. Interfacing to this microprocessor board is the ability to digitize sensor data and other miscellaneous data such as PLGR (GPS) input. The system runs from 8V to 32V DC, which is suitable for military vehicle systems as well as commercial vehicle systems. The Driver Display provides a removable FLASH card which may be used for route information, as well as logging vehicle information which can be viewed later. This permits routes to be loaded from a central point or locally. The unit has the ability to backtrack through a route that has already been taken.

In a preferred embodiment of the Driver Display, all parts are operational within industrial temperature ranges, can operate in an input voltage range of about 8V to 32V (thereby easily accommodating 12V batteries or 24V systems), and are flexible through utilization of an FPGA (field programmable gate array).

### EXAMPLE 7

### Multi-Node System

In a variation of Example 6, MNIN is incorporated into a system including a combination of nodes serving as a Vehicle Display System (VDS). This system uses a display node to provide information to a user. This unit communicates by means of the network interface to a sensor interface node, GPS node, power node, and any other variety of MNIN. The sensor interface node communicates received sensor data to the display node. The GPS node provides additional GPS information to the display node. The “power node” uses information from the display node to activate switches as desired by the user. This system can be expanded to include multiple sensor interface nodes as well as additional power nodes for controlling various other systems. The VDS also interfaces with a communications node to control radio equipment. The system is expandable to a multitude of MNIN's configured for various other functions.

While the above description contains many specificities, these should not be construed as limitations on the scope of the invention, but rather as exemplification of preferred embodiments. Numerous other variations of the present invention are possible, and it is not intended herein to mention all of the possible equivalent forms or ramifications of this invention. Various changes may be made to the present invention without departing from the scope of the invention.

What is claimed:

1. A node for providing a common interface for a plurality of system devices connected to a network, comprising:
(a) user-configurable software for providing a software interface for said plurality of system devices; and
(b) multifunctional hardware for providing a hardware interface for said plurality of system devices.

2. The node of claim 1, further comprising at least one system device connected to said node, wherein said at least one system device is a digital device, an analog device, or a serial device.

3. The node of claim 2, wherein said node provides a switching functionality, whereby the voltage output of said system devices is standardized to a level of about 0 to 5 voltz, about minus 5 to 5 voltz, or about minus 12 to 12 voltz.

4. The node of claim 2, wherein said node provides a switching functionality, whereby the electronic communication formats of said system devices are standardized to a single communication protocol.

5. The node of claim 1, further comprising at least one processing unit connected to said node through said network for processing information received from, and sending information to, said system devices.

6. The node of claim 1, wherein said plurality of system devices consists of digital devices.

7. The node of claim 1, wherein said plurality of system devices consists of analog devices.

8. The node of claim 1, wherein said plurality of system devices consists of serial devices.

9. The node of claim 1, wherein said plurality of system devices consists of digital devices, analog devices, serial devices, or combinations thereof.

10. The node of claim 1, wherein said network is a Controller Area Network.

11. The node of claim 1, wherein said network is any network compatible with said node and said system devices.

12. The node of claim 1, wherein said user-configurable software is expandable and updatable across said network.

13. The node of claim 1, wherein said user-configurable software further comprises:
(a) an application manager layer for facilitating multiprocessing, resource allocation, memory management and cooperation among independent application modules;
(b) application modules layer for application-dependent processing of system inputs and outputs; and
(c) a hardware abstraction layer to consolidate all hardware interfaces accessible from application modules.

14. The node of claim 1, wherein said multifunctional hardware further comprises:
(a) memory for storing said user-configurable software;
(b) a microprocessing subunit for controlling the operation of said hardware as commanded by said user-configurable software;
(c) a plurality of inputs/outputs in communication with said microprocessing subunit for connecting to said system devices, and
(d) a power supply.

15. The node of claim 14, wherein said memory further comprises a volatile memory module and a non-volatile memory module.

16. The node of claim 14, wherein said microprocessing subunit further comprises a microprocessor chip.

17. The node of claim 14, wherein said microprocessing subunit further comprises an address and data bus interface in communication with said memory.

18. The node of claim 14, wherein said microprocessing subunit further comprises an asynchronous serial port in communication with a serial device transceiver in communication with a high-speed serial interface connector.

19. The node of claim 14, wherein said microprocessing subunit further comprises a synchronous serial port in communication with a synchronous serial port interface connector.

20. The node of claim 14, wherein said microprocessing subunit further comprises a background debugging monitor in communication with a background debugging monitor interface connector.

21. The node of claim 14, wherein said microprocessing subunit further comprises a network interface in communication with a network connector.

22. The node of claim 14, wherein said microprocessing subunit further comprises an analog to digital converter in communication with an analog to digital and digital I/O interface connector.

23. The node of claim 14, wherein said microprocessing subunit further comprises a time processing unit in communication with a switch array in communication with a digital I/O and serial interface connector.

24. The node of claim 14, wherein said plurality of inputs/outputs further comprises a plurality of digital input/outputs.

25. The node of claim 14, wherein said plurality of inputs/outputs further comprises a plurality of analog input/outputs.

26. The node of claim 14, wherein said plurality of inputs/outputs further comprises a plurality of serial input/outputs.

27. The node of claim 14, wherein said plurality of inputs/outputs consists of a plurality of digital input/outputs, analog input/outputs, serial input/outputs, or combinations thereof.

28. The node of claim 14, wherein said power supply operates within a range of about 8 to 32V DC.

29. The node of claim 14, wherein said power supply draws its power from either an external power source or the power supply to said network, and automatically chooses said external power supply when both sources of power are available.

30. The node of claim 1, wherein all components of said node are ruggedized to prevent damage resulting from use of said node in high shock or high vibration environments.

31. The node of claim 1, wherein said node operates within a temperature range of about minus 40° C. to 85° C.

32. The node of claim 1, wherein said node is installed in landcraft, aircraft, or watercraft.

33. A node for providing a common interface for a plurality of system devices connected to a network, comprising:
(a) user-configurable software for providing a software interface for said plurality of system devices wherein said user-configurable software further comprises:
(1) an application manager layer for facilitating multiprocessing, resource allocation, memory management and cooperation among independent application modules;
(2) application modules layer for application-dependent processing of system inputs and outputs; and
(3) a hardware abstraction layer to consolidate all hardware interfaces accessible from application modules; and
(b) multifunctional hardware for providing a hardware interface for said plurality of system devices, wherein said multifunctional hardware further comprises:
(1) memory for storing said user-configurable software;
(2) a microprocessing subunit for controlling the operation of said hardware as commanded by said user-configurable software;
(3) a plurality of inputs/outputs in communication with said microprocessing subunit for connecting to said system devices; and
(4) a power supply.

34. The node of claim 33, further comprising at least one system device connected to said node, wherein said at least one system device is a digital device, an analog device, or a serial device.

35. The node of claim 33, wherein said node provides a switching functionality, whereby the voltage output of said system devices is standardized to a level of about 0 to 5 voltz, about minus 5 to 5 voltz, or about minus 12 to 12 voltz.

36. The node of claim 33, wherein said node provides a switching functionality, whereby the electronic communication formats of said system devices are standardized to a single communication protocol.

37. The node of claim 33, further comprising at least one processing unit connected to said node through said network for processing information received from, and sending information to, said system devices.

38. The node of claim 33, wherein said plurality of system devices consists of digital devices.

39. The node of claim 33, wherein said plurality of system devices consists of analog devices.

40. The node of claim 33, wherein said plurality of system devices consists of serial devices.

41. The node of claim 33, wherein said plurality of system devices consists of digital devices, analog devices, serial devices, or combinations thereof.

42. The node of claim 33, wherein said network is a Controller Area Network.

43. The node of claim 33, wherein said network is any network compatible with said node and said system devices.

44. The node of claim 33, wherein said user-configurable software is expandable and updatable across said network.

45. The node of claim 33, wherein said memory further comprises a volatile memory module and a non-volatile memory module.

46. The node of claim 33, wherein said microprocessing subunit further comprises a microprocessor chip.

47. The node of claim 33, wherein said microprocessing subunit further comprises an address and data bus interface in communication with said memory.

48. The node of claim 33, wherein said microprocessing subunit further comprises an asynchronous serial port in communication with a serial device transceiver in communication with a high-speed serial interface connector.

49. The node of claim 33, wherein said microprocessing subunit further comprises a synchronous serial port in communication with a synchronous serial port interface connector.

50. The node of claim 33, wherein said microprocessing subunit further comprises a background debugging monitor in communication with a background debugging monitor interface connector.

51. The node of claim 33, wherein said microprocessing subunit further comprises a network interface in communication with a network connector.

52. The node of claim 33, wherein said microprocessing subunit further comprises an analog to digital converter in communication with an analog to digital and digital I/O interface connector.

53. The node of claim 33, wherein said microprocessing subunit further comprises a time processing unit in communication with a switch array in communication with a digital I/O and RS-232 interface connector.

54. The node of claim 33, wherein said plurality of inputs/outputs further comprises a plurality of digital input/outputs.

55. The node of claim 33, wherein said plurality of inputs/outputs further comprises a plurality of analog input/outputs.

56. The node of claim 33, wherein said plurality of inputs/outputs further comprises a plurality of serial input/outputs.

57. The node of claim 33, wherein said plurality of inputs/outputs consists of a plurality of digital input/outputs, analog input/outputs, serial input/outputs, or combinations thereof.

58. The node of claim 33, wherein said power supply operates within a range of about 8 to 32V DC.

59. The node of claim 33, wherein said power supply draws its power from either an external power source or the power supply to said network, and automatically chooses said external power supply when both sources of power are available.

60. The node of claim 33, wherein all components of said node are ruggedized to prevent damage resulting from use of said node in high shock or high vibration environments.

61. The node of claim 33, wherein said node operates within a temperature range of about minus 40° C. to 85° C.

62. The node of claim 33, wherein said node is installed in landcraft, aircraft, or watercraft.

63. A system for automated control of a plurality of system devices, comprising:
(a) a node for providing a common interface for said plurality of system devices, further comprising: user-configurable software for providing a software interface for said plurality of system devices; and multifunctional hardware for providing a hardware interface for said plurality of system devices;
(b) a plurality of digital, analog, serial, or other system devices in communication with said node by means of a network; and
(c) a processing unit in communication with said node by means of said network for communicating with and controlling said system devices.

64. A method for communicating with a variety of system devices from at least one processing terminal, comprising:
(a) connecting said system devices to a multifunctional network interface node further comprising a user-configurable software interface; and a hardware interface, whereby said node standardizes the voltage output levels and electronic communications protocols of said system devices; and
(b) connecting said multifunctional network interface node to a processing unit by means of a network, whereby said information from said system devices may be received and processed, and commands may be sent to said system devices.
